(19) United States
(12) Patent Application Publication
(10) Pub. No.: US 2024/0126252 A1
(43) Pub. Date: Apr. 18, 2024

(54) METHOD FOR SUGGESTING EQUIPMENT MAINTENANCE, ELECTRONIC DEVICE AND COMPUTER READABLE RECORDING MEDIUM

(71) Applicant: Wistron Corporation, New Taipei City (TW)

(72) Inventors: Chun-Hsien Li, New Taipei City (TW); Chia-Chiung Liu, New Taipei City (TW)

(73) Assignee: Wistron Corporation, New Taipei City (TW)

(21) Appl. No.: 18/083,583

(22) Filed: Dec. 19, 2022

(30) Foreign Application Priority Data
Oct. 14, 2022 (TW) 111139137

(51) Int. Cl. G05B 23/02

(52) U.S. Cl. CPC G05B 23/0272; G05B 23/024; G05B 23/0283

(57) ABSTRACT

The disclosure provides a method for suggesting equipment maintenance, an electronic device, and a computer readable recording medium. Equipment operation information of equipment is obtained. An energy efficiency of the equipment is determined according to the equipment operation information. Status difference data of the equipment is generated according to the equipment operation information in response to the energy efficiency meeting a maintenance condition. At least one maintenance item corresponding to the equipment is determined according to the status difference data. Suggestion information of the at least one maintenance item is provided through a display.

### CROSS-REFERENCE TO RELATED APPLICATION

This application claims the priority benefit of Taiwanese application no. 111139137, filed on Oct. 14, 2022. The entirety of the above-mentioned patent application is hereby incorporated by reference herein and made a part of this specification.

### BACKGROUND

### Technical Field

The disclosure relates to a method of energy conservation. In particular, the disclosure relates to a method for suggesting equipment maintenance, an electronic device, and a computer readable recording medium.

### Description of Related Art

With the increasing importance of environmental protection issues such as greenhouse gas reduction, energy conservation, and carbon reduction, energy conservation has currently become one of the key development projects. If the reasons for electricity waste can be effectively found and the suitable approach to energy conservation can be provided, it not only contributes to environmental protection, but also benefits factory costs and profits.

Electricity is required for operating equipment. As an operating time increases, energy efficiency of the equipment may gradually decrease due to wearing of parts or various other reasons. Equipment with relatively low energy efficiency requires to consume relatively great electricity to reach the operating target, or even fail to operate normally, resulting in waste of electricity. Accordingly, maintenance measures for equipment are also an important link for electricity conservation. Maintenance measures can improve the energy efficiency of the equipment, accordingly conserving electricity and reducing factory operating costs. In general, regular maintenance (for example, carried out every six months) is adopted for most equipment. However, regular maintenance is not suitable for all equipment. Specifically, based on differences in equipment operation or various other reasons, some equipment may require maintenance before reaching the due date of regular maintenance, but some equipment may not require maintenance after reaching the due date of regular maintenance. In addition, there are multiple maintenance items for single equipment, and it is typically required to rely on experiences of professionals for inspection on the equipment so as to know the maintenance items and the number of maintenance consumables that meet the actual requirements. In other words, it may not be effortless to judge the timing and content of the maintenance measures, which may thus lead to an increase in electricity consumption and in energy costs.

### SUMMARY

The disclosure provides a method for suggesting equipment maintenance, an electronic device, and a computer readable recording medium.

An embodiment of the disclosure provides a method for suggesting equipment maintenance including the following. Equipment operation information of equipment is obtained. Energy efficiency of the equipment is determined according to the equipment operation information. Status difference data of the equipment is generated according to the equipment operation information in response to the energy efficiency meeting a maintenance condition. At least one maintenance item corresponding to the equipment is determined according to the status difference data. Suggestion information of the at least one maintenance item is provided through a display.

An embodiment of the disclosure provides an electronic device including a display, a storage circuit, and a processor. The storage circuit stores a plurality of instructions. The processor is coupled to the display and the storage circuit. The processor accesses the instructions to: obtain equipment operation information of equipment; determine energy efficiency of the equipment according to the equipment operation information; generate status difference data of the equipment according to the equipment operation information in response to the energy efficiency meeting a maintenance condition; determine at least one maintenance item corresponding to the equipment according to the status difference data; and provide suggestion information of the at least one maintenance item through the display.

An embodiment of the disclosure provides a computer readable recording medium storing a program, and perform the method for suggesting equipment maintenance in response to a computer loads and executes the program.

Based on the foregoing, in the embodiments of the disclosure, it is possible to continuously monitor the energy efficiency of the equipment to immediately determine whether the equipment requires maintenance, and to determine the maintenance item that meets the actual requirements of the equipment through the machine learning model. Based on this, maintenance measures can accordingly be taken at reasonable timings, and the maintenance costs may be effectively reduced.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic diagram of an electronic device according to an embodiment of the disclosure.

FIG. 2 is a flowchart of a method for suggesting equipment maintenance according to an embodiment of the disclosure.

FIG. 3 is a flowchart of a method for suggesting equipment maintenance according to an embodiment of the disclosure.

FIG. 4 is a flowchart of generating status difference data according to an embodiment of the disclosure.

FIG. 5A to FIG. 5C are each a flowchart of determining a maintenance item according to an embodiment of the disclosure.

FIG. 6 is a schematic diagram of maintenance benefit assessment information according to an embodiment of the disclosure.

FIG. 7 is a schematic diagram of an operation interface with maintenance benefit assessment information according to an embodiment of the disclosure.

### DESCRIPTION OF THE EMBODIMENTS

Some embodiments of the disclosure accompanied with the drawings will be described in detail below. The same reference numerals in the following description and in different drawings will be regarded as the same or similar elements. These embodiments are only part of the disclosure and do not disclose all possible implementations of the disclosure. More specifically, these embodiments are only exemplary of the method, the device, and the medium within the scope of the appended claims of the disclosure.

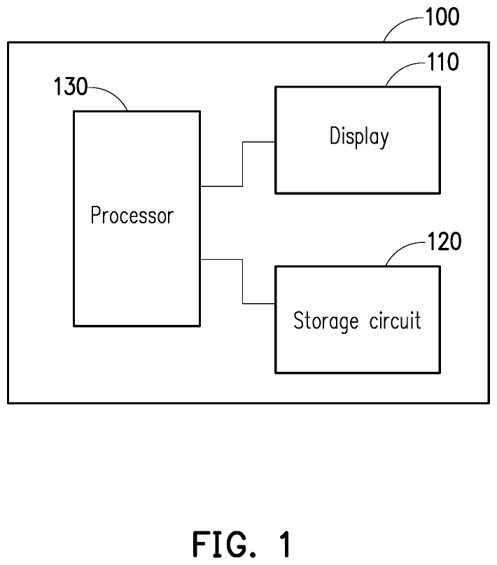

With reference to FIG. 1, FIG. 1 is a schematic diagram of an electronic device according to an embodiment of the disclosure. In various embodiments, an electronic device 100 is, for example, a computer device with computing capability, such as a notebook computer, a desktop computer, a server, and a workstation, but may not be limited thereto. The electronic device 100 may include a display 110, a storage circuit 120, and a processor 130.

The display 110 is, for example, a display in various forms such as a liquid crystal display (LCD), a light-emitting diode (LED) display, an organic light-emitting diode (OLED) display built in the electronic device 100, but may not be limited thereto. In other embodiments, the display 110 may also be any display device externally connected to the electronic device 100.

The storage circuit 120 is, for example, any form of fixed or removable random access memory (RAM), read-only memory (ROM), flash memory, a hard disk, or other similar devices or a combination of these devices, and may record a plurality of instructions, programming codes, or software modules.

The processor 130 is, for example, a central processing unit (CPU), an application processor (AP), or any other programmable general-purpose or special-purpose microprocessor, digital signal processor (DSP), image signal processor (ISP), graphics processing unit (GPU), or other similar devices, an integrated circuit, or a combination thereof. The processor 130 may access and execute the software modules recorded in the storage circuit 120 to realize the method for suggesting equipment maintenance in the embodiments of the disclosure. The software modules may be broadly interpreted to denote instructions, instruction sets, codes, programming codes, programs, applications, software suites, threads, processes, functions, or the like, be they referred to as software, firmware, intermediate software, microcode, hardware description languages, or the like.

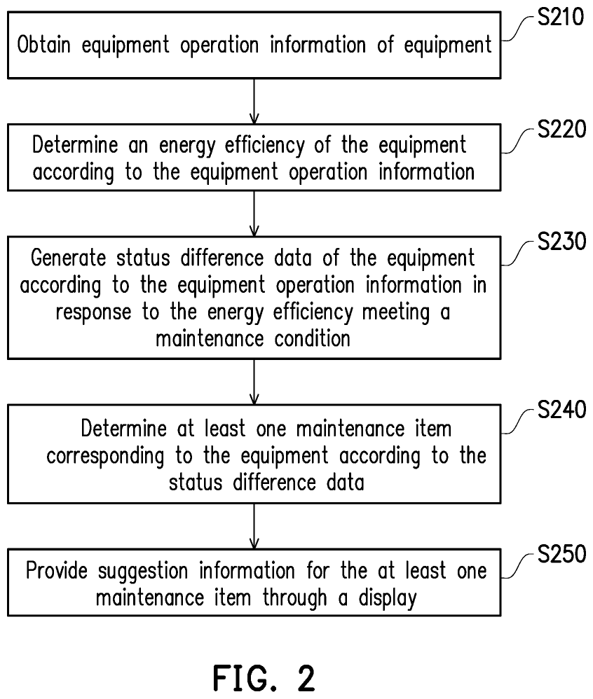

FIG. 2 is a flowchart of a method for suggesting equipment maintenance according to an embodiment of the disclosure. With reference to FIG. 1 and FIG. 2, the method of this embodiment is adapted for the electronic device 100 in the embodiment above. The steps of the method for suggesting equipment maintenance of this embodiment accompanied with the elements in the electronic device 100 will be described in detail below.

In step S210, the processor 130 obtains equipment operation information of equipment. In the embodiment of the disclosure, the equipment may be various machine equipment in a factory, such as production equipment, air compression equipment, air conditioning equipment, or the like. The equipment operation information of the equipment may include electricity consumption data, equipment status data, equipment production data, or the like. The equipment operation information of the equipment may be obtained from sensing and measurement by a sensor or measuring instrument. The sensor or the measuring instrument may include an electricity meter, a thermometer, a hygrometer, a pressure gauge, and the like, which is not limited by the disclosure. Alternatively, the equipment operation information of the equipment may be obtained from a product production plan or a factory manufacturing logbook recorded in the storage circuit 120.

In step S220, the processor 130 determines energy efficiency of the equipment according to the equipment operation information. The energy efficiency of the equipment may indicate the operation efficiency of the equipment under a unit electricity consumption. In some embodiments, the processor 130 obtains at least one production data of the equipment from the equipment operation information, and determines the energy efficiency according to a ratio of the at least one production data to electricity consumption of the equipment. The processor 130 may check the energy efficiency of the equipment every unit period according to the equipment operation information of the equipment. The time length of the unit period may be one week, one day, one hour, one minute, or the like, which is not limited by the disclosure.

In some embodiments, the production data may be generated by a sensor or a measuring instrument on the equipment. In some embodiments, the production data may be generated by a sensor or a measuring instrument deployed in a factory. In some embodiments, the production data may be determined according to data in the product production plan.

In some embodiments, the energy efficiency of the equipment is a parameter determined according to the production data and the electricity consumption of the equipment. The production data is determined according to the form of the equipment. For example, assuming that the equipment is an air compressor, the processor 130 may calculate the output volume of the air compressor under a unit electricity consumption to obtain the energy efficiency of the air compressor. For example, the energy efficiency of the air compressor may be the output volume per hour divided by electricity consumption of that hour. Assuming that the equipment is production equipment, the processor 130 may calculate the product production amount of the production equipment under a unit electricity consumption to obtain the energy efficiency of the production equipment. For example, the energy efficiency of the production equipment may be the product production amount per hour divided by electricity consumption of that hour. Assuming that the equipment is an air conditioner, the processor 130 may calculate the difference between indoor and outdoor temperatures caused by the air conditioner under a unit electricity consumption to obtain the energy efficiency of the air conditioner. For example, the energy efficiency of the air conditioner may be the difference between indoor and outdoor temperatures per hour divided by electricity consumption of that hour.

In step S230, the processor 130 generates status difference data of the equipment according to the equipment operation information in response to the energy efficiency meeting a maintenance condition. Specifically, the processor 130 may obtain the energy efficiency of the equipment every unit period according to the equipment operation information of the equipment, and may immediately inspect whether the equipment may require maintenance according to the energy efficiency. When the processor 130 determines that the equipment may require maintenance according to the energy efficiency, the processor 130 may generate the status difference data of the equipment according to the equipment operation information, to determine at least one maintenance item applicable to the equipment in subsequent operations based on the status difference data. The processor 130 may generate the status difference data of the equipment by comparing equipment operation information collected during a past reference time interval with equipment operation information collected during a current time interval.

In some embodiments, the processor 130 determines whether the energy efficiency meets the maintenance condition. In some embodiments, the processor 130 may determine whether the energy efficiency meets the maintenance condition according to whether the energy efficiency is less than a predetermined threshold. If the energy efficiency is less than a predetermined threshold, it means that the energy efficiency meets the maintenance condition, that is, the equipment is in a low energy efficiency state and may require maintenance. Comparatively, if the energy efficiency is not less than the predetermined threshold, it means that the energy efficiency does not meet the maintenance condition. Alternatively, in some embodiments, the processor 130 may obtain an energy efficiency measurement indicator by comparing the energy efficiency with predetermined energy efficiency, and determine whether the energy efficiency meets the maintenance condition by comparing the energy efficiency measurement indicator with a measurement threshold. Specifically, the processor 130 may obtain the energy efficiency measurement indicator by dividing the current energy efficiency by the predetermined energy efficiency of the equipment, and the energy efficiency measurement indicator may be a value from 0 to 1. The predetermined energy efficiency may be a factory default value. The processor 130 may determine whether the energy efficiency meets the maintenance condition according to whether the energy efficiency measurement indicator is less than the measurement threshold. If the energy efficiency measurement indicator is less than the measurement threshold, it means that the energy efficiency meets the maintenance condition, that is, the equipment is in a low energy efficiency state and may require maintenance. Comparatively, if the energy efficiency measurement indicator is not less than the measurement threshold, it means that the energy efficiency does not meet the maintenance condition.

In step S240, the processor 130 determines the at least one maintenance item corresponding to the equipment according to the status difference data. In some embodiments, when the processor 130 determines that the equipment may require maintenance according to the energy efficiency, the processor 130 may determine the maintenance item applicable to the equipment with a machine learning model. Specifically, the processor 130 may establish the machine learning model according to historical maintenance records of the equipment. The machine learning model trained based on machine learning algorithms may be recorded in the storage circuit 120. In other words, the processor 130 may perform machine learning according to historical maintenance records as a training data set to create a machine learning model for identifying the maintenance item applicable to the equipment according to input data. Based on this, the processor 130 may automatically and immediately identify the maintenance item applicable to the equipment to provide the maintenance item to equipment managing personnel for reference.

In step S250, the processor 130 provides suggestion information of the at least one maintenance item through the display 110. In other words, the processor 130 may provide the suggestion information associated with the maintenance item through the display 110 for the factory manager to take maintenance measures on the equipment according to the suggestion information of the maintenance item. Accordingly, the equipment managing personnel of the factory may immediately find out which equipment requires maintenance, and take appropriate maintenance measures according to the suggestion information of the maintenance item, accordingly preventing energy waste and saving factory operating costs. The suggestion information associated with the maintenance item may include a consumables quantity, maintenance benefit assessment information, and the like of the maintenance item.

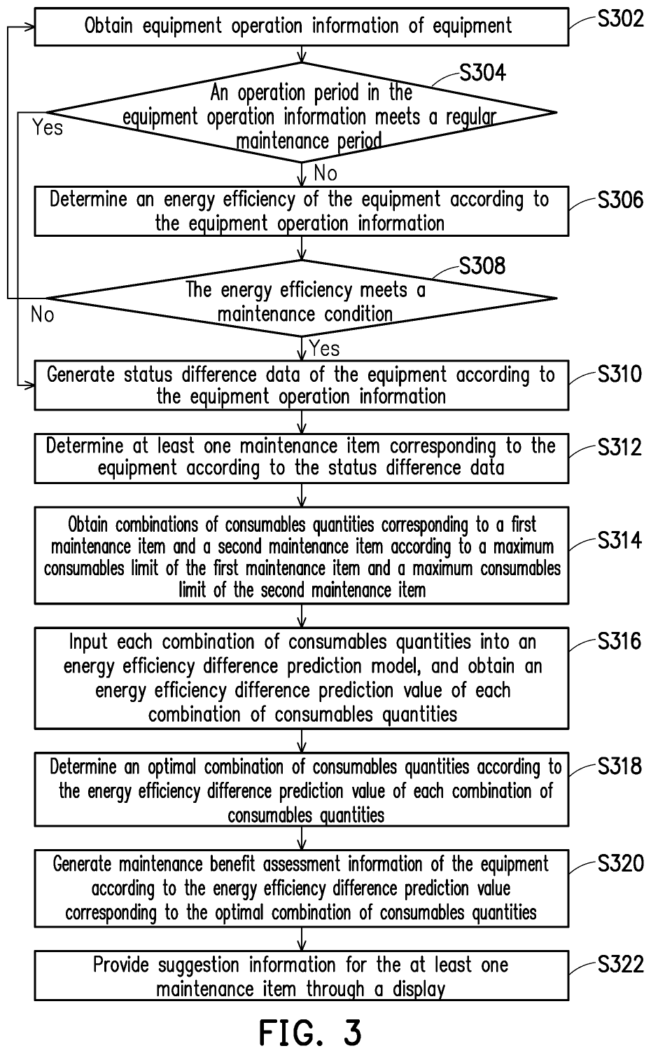

FIG. 3 is a flowchart of a method for suggesting equipment maintenance according to an embodiment of the disclosure. With reference to FIG. 1 and FIG. 3, the method of this embodiment is adapted for the electronic device 100 in the embodiment above. The steps of the method for suggesting equipment maintenance of this embodiment accompanied with the elements in the electronic device 100 will be described in detail below.

In step S302, the processor 130 obtains equipment operation information of equipment. In step S304, the processor 130 determines whether an operation period in the equipment operation information corresponds to a regular maintenance period. The regular maintenance period is, for example, 6 months, 4,000 hours, or the like. The regular maintenance period may be determined depending on the actual application, and is not limited by the disclosure. After each time a maintenance for the equipment is completed, the processor 130 may re-accumulate the operation period of the equipment. In response to the operation period of the equipment corresponds to the regular maintenance period (determined to be YES in step S304), the processor 130 determines to perform maintenance assessment and performs step S310. In other words, in step S310, the processor 130 generates status difference data of the equipment according to the equipment operation information in response to the operation period in the equipment operation information corresponding to the regular maintenance period.

Comparatively, in response to the operation period of the equipment does not meet the regular maintenance period (determined to be NO in step S304), in step S306, the processor 130 determines energy efficiency of the equipment according to the equipment operation information. Next, in step S308, the processor 130 determines whether the energy efficiency meets a maintenance condition. In other words, before the operation period of the equipment is accumulated to be equal to the regular maintenance period, the processor 130 may continuously monitor whether the energy efficiency of the equipment meets the maintenance condition to determine whether to perform maintenance assessment. For example, the processor 130 may calculate the energy efficiency every hour, and determine whether the energy efficiency meets the maintenance condition every hour.

In response to the energy efficiency meets the maintenance condition (determined to be YES in step S308), the processor 130 determines to perform maintenance assessment and performs step S310. In other words, in step S310, the processor 130 generates the status difference data of the equipment according to the equipment operation information in response to the energy efficiency meeting the maintenance condition. In addition, in some embodiments, the processor 130 may also provide a prompt notification associated with the equipment to equipment managing personnel in response to the energy efficiency meeting the maintenance condition. The prompt notification may include a visual prompt notification or an audible prompt notification. In response to the energy efficiency does not meet the maintenance condition (determined to be NO in step S308), the processor 130 returns to step S302 to continue monitoring the energy efficiency of the equipment.

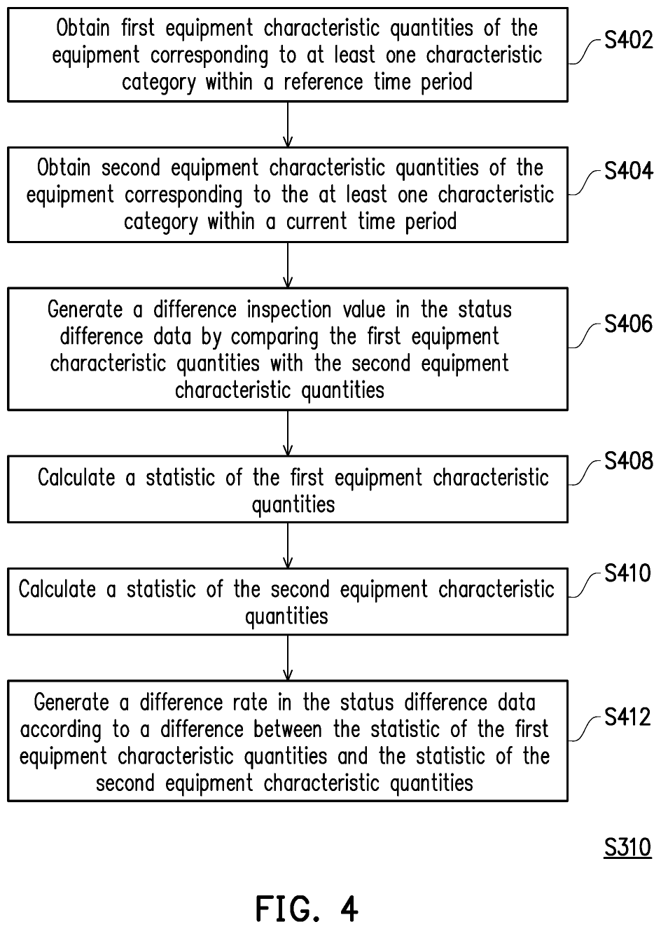

In addition, with reference to FIG. 4, FIG. 4 is a flowchart of generating status difference data according to an embodiment of the disclosure. Step S310 may be implemented as step S402 to step S412.

In step S402, the processor 130 obtains a plurality of first equipment characteristic quantities of the equipment corresponding to at least one characteristic category within a reference time interval. The processor 130 may determine the reference time interval for assessing the recent condition of the equipment. For example, the reference time interval may be the previous 2 days, but the length of the reference time interval is not limited by the disclosure. Next, the processor 130 may obtain the first equipment characteristic quantities corresponding to the at least one characteristic category within the reference time interval from the equipment operation information. For example, assuming that the equipment is an air compressor and the unit of time of sampling the first equipment characteristic quantities is 1 hour, the at least one characteristic category may include an output volume category, an output temperature category, and a pressure category. The processor 130 may obtain 48 first output volumes corresponding to the output volume category, 48 first output temperatures corresponding to the output temperature category, and 48 first equipment pressures corresponding to the pressure category within the previous 2 days from the equipment operation information.

In step S404, the processor 130 obtains a plurality of second equipment characteristic quantities of the equipment corresponding to the at least one characteristic category within a current time interval. For example, the current time interval may be a time interval of 24 hours backward from the current time point. The reference time interval and the current time interval may or may not overlap, which is not limited by the disclosure. For example, assuming that the current time point is 2:00 pm on March 5th, then the reference time interval may be from 12:00 am on March 3rd to 12:00 am on March 5th, and the current time interval may be from 2:00 pm on March 4th to 2:00 pm on March 5th. Alternatively, for example, assuming that the current time is 2:00 pm on March 5th, then the reference time interval may be from 12:00 am on March 2nd to 12:00 am on March 4th, and the current time interval may be from 2:00 pm on March 4th to 2:00 pm on March 5th. The processor 130 may obtain the second equipment characteristic quantities corresponding to the at least one characteristic category within the current time interval from the equipment operation information. For example, assuming that the equipment is an air compressor and the unit of time of sampling the second equipment characteristic quantities is 1 hour, the at least one characteristic category may include an output volume category, an output temperature category, and a pressure category. The processor 130 may obtain 24 second output volumes corresponding to the output volume category, 24 second output temperatures corresponding to the output temperature category, and 24 second equipment pressures corresponding to the pressure category within the previous 24 hours from the equipment operation information.

In addition, in some embodiments, assuming that the equipment is an air compressor, the at least one characteristic category may further include an in-pipe output category, an in-pipe temperature category, and an in-pipe pressure category. By measuring the output volume, the temperature, and the pressure in the pipeline in communication with the air compressor, the processor 130 may obtain the first equipment characteristic quantities and the second equipment characteristic quantities corresponding to the in-pipe output category, the in-pipe temperature category, and the in-pipe pressure category.

In step S406, the processor 130 generates a difference inspection value in the status difference data by comparing the first equipment characteristic quantities with the second equipment characteristic quantities. In some embodiments, the processor 130 may perform a Wilcoxon signed-rank test to assess the difference between the data sample formed by the first equipment characteristic quantities and the data sample formed by the second equipment characteristic quantities. In other words, the processor 130 may perform a Wilcoxon signed-rank test on the data sample formed by the first equipment characteristic quantities and the data sample formed by the second equipment characteristic quantities to generate a P-value in the status difference data. In general, a P-value less than 0.05 indicates a difference between two data samples.

In step S408, the processor 130 calculates a statistic of the first equipment characteristic quantities. The processor 130 may perform statistical analysis of the first equipment characteristic quantities to obtain the statistic, where the statistic is, for example, an average or a median. For example, the processor 130 may calculate an average of the 48 first output volumes within the reference time interval. The processor 130 may calculate an average of the 48 first output temperatures within the reference time interval. The processor 130 may calculate an average of the 48 first pressures within the reference time interval.

In step S410, the processor 130 calculates a statistic of the second equipment characteristic quantities. The processor 130 may perform statistical analysis of the second equipment characteristic quantities to obtain the statistic, where the statistic is, for example, an average or a median. For example, the processor 130 may calculate an average of the 24 second output volumes within the current time interval. The processor 130 may calculate an average of the 24 second output temperatures within the current time interval. The processor 130 may calculate an average of the 24 second pressures within the current time interval.

In step S412, the processor 130 generates a difference rate in the status difference data according to a difference between the statistic of the first equipment characteristic quantities and the statistic of the second equipment characteristic quantities. Here, the difference rate is a percentage value. The processor 130 may first calculate the difference between the statistic of the first equipment characteristic quantities and the statistic of the second equipment characteristic quantities, and then divide the difference by the statistic of the second equipment characteristic quantities to obtain the difference rate. For example, Table 1 shows an example of the average of the first characteristic quantities, the average of the second characteristic quantities, and the status difference data generated according to the steps shown in FIG. 4.

TABLE 1

| | | | | Difference |
|---|---|---|---|---|
| | Average of 1st | Average of 2nd | | inspection |
| Characteristic | characteristic | characteristic | Difference | value |
| category | quantities | quantities | rate | (P-value) |
| Output volume | 3150 (CMH) | 3280 (CMH) | −3.96% | 0.004 |
| Output | 38.1 degrees | 34.5 degrees | 9.45% | 0.001 |
| temperature | | | | |
| Equipment | 0.74 | 0.75 | −1.35% | 0.195 |
| pressure | | | | |

Note that Table 1 only serves for exemplary description, and the processor 130 may not calculate the difference inspection value in some other embodiments.

With reference back to FIG. 3, in step S312, the processor 130 determines at least one maintenance item corresponding to the equipment according to the status difference data. In some embodiments, the processor 130 may assess whether a significant difference exists between the first equipment characteristic quantities corresponding to the reference time interval and the second equipment characteristic quantities corresponding to the current time interval according to the difference inspection value in the status difference data. If a significant difference exists, it indicates that the energy efficiency of the equipment may have been significantly reduced. Accordingly, the processor 130 may input the difference rate in the status difference data to a machine learning model, and determine the at least one maintenance item according to information output by the model. In other words, the machine learning model may learn the relationship between the difference between the equipment characteristic quantities and the maintenance item according to the training data.

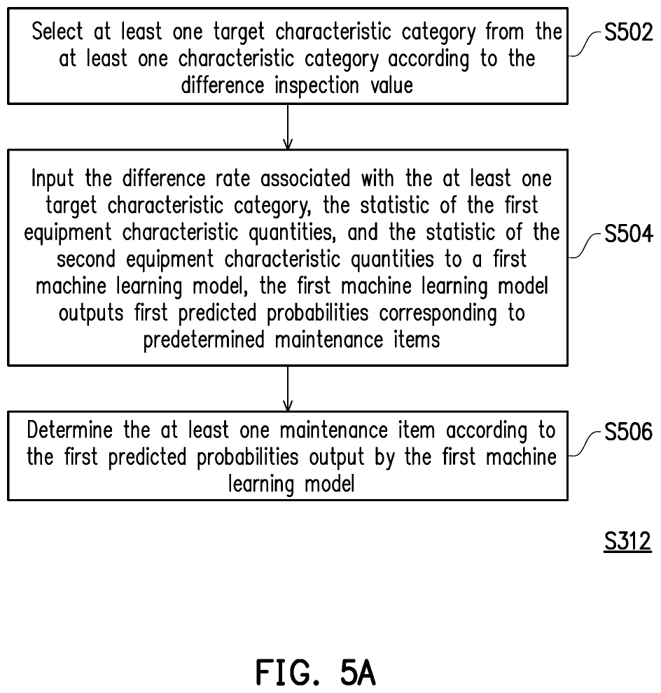

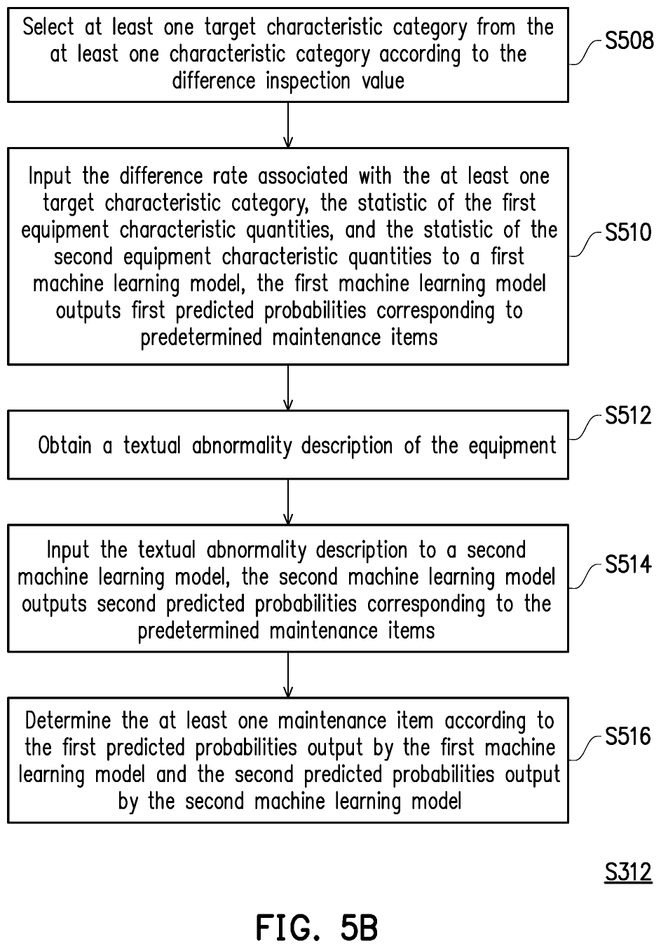

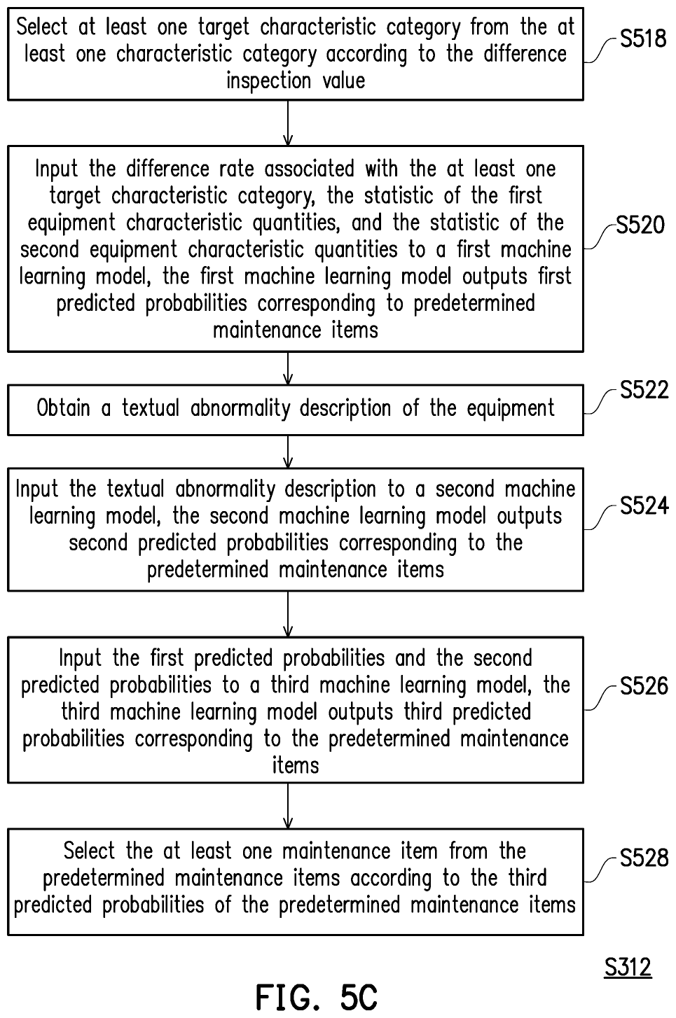

With reference to FIG. 5A, FIG. 5A is a flowchart of determining a maintenance item according to an embodiment of the disclosure. Step S312 may be implemented as step S502 to step S506.

In step S502, the processor 130 selects at least one target characteristic category from the at least one characteristic category according to the difference inspection value. The processor 130 may select the at least one target characteristic category by comparing the difference inspection value with a difference threshold. In some embodiments, the processor 130 may determine whether the difference inspection value corresponding to each characteristic category is less than the difference threshold to select the at least one target characteristic category according to the determination result. If the difference inspection value corresponding to the characteristic category is less than the difference threshold, it indicates abnormality in the characteristic category of the equipment. Taking Table 1 as an example, it is assumed that the difference threshold is 0.05. Since the difference inspection value corresponding to the output volume category and the difference inspection value corresponding to the output temperature category are each less than 0.05, the processor 130 may select the output volume category and the output temperature category as the target characteristic category.

In step S504, the processor 130 inputs the difference rate associated with the at least one target characteristic category, the statistic of the first equipment characteristic quantities, and the statistic of the second equipment characteristic quantities to a first machine learning model, the first machine learning model outputs a plurality of first predicted probabilities corresponding to a plurality of predetermined maintenance items. The first machine learning model is, for example, a support vector machine (SVM) model, a random forest model, or the like. Nonetheless, the type of the model is not limited by the disclosure, and may be determined depending on the actual application.

Specifically, assuming that the equipment is an air compressor, the predetermined maintenance items may include oil mist separator, air intake filter, oil filter, lubricant, and coolant. For example, assuming that the number of predetermined maintenance items is N, the first machine learning model may output N first predicted probabilities corresponding to the predetermined maintenance items. Following the example of Table 1 for further description, Table 2 may be an example of input data and output data of the first machine learning model according to an embodiment of the disclosure.

TABLE 2

| Model input data | Model output data |
|---|---|
| Average of the 1st output volume: 3150 | 1st predicted probabilities of |
| Average of 2nd output volume: 3280 | predetermined maintenance items: |
| Difference rate between 1st output volume and | (0.001, 0.350, 0.002, 0.495, |
| 2nd output volume: −3.96% | 0.152) |
| Average of 1st output temperature: 38.1 | |
| Average of 2nd output temperature: 34.5 | |
| Difference rate between 1st output temperature | |
| and 2nd output temperature: 9.45% | |

The processor 130 may input the model input data shown in Table 2 to the first machine learning model, such that the first machine learning model outputs a first predicted probability “0.001” corresponding to “oil mist separator”, a first predicted probability “0.350” corresponding to “air intake filter”, a first predicted probability “0.002” corresponding to “oil filter”, a first predicted probability “0.495” corresponding to “lubricant”, and a first predicted probability “0.152” corresponding to “coolant”.

In the embodiment of FIG. 5A, the processor 130 first selects the target characteristic category (e.g., the output volume category and the output temperature category shown in Table 2) according to the difference inspection value, and then selectively inputs data about the target characteristic category to the machine learning model to save computing resources. For example, since the difference inspection value corresponding to the pressure category is not less than the difference threshold, the processor 130 may set the model input data (i.e., the average of the first pressure value, the average of the second pressure value, and the difference rate between the first pressure value and the second pressure value) corresponding to the pressure category to 0, and then input the model input data to the first machine learning model.

Nonetheless, in some other embodiments, instead of calculating the difference inspection value, the processor 130 may directly input the actual data for each characteristic category to the machine learning model to obtain accurate prediction results. The processor 130 may input the difference rate, the statistic of the first equipment characteristic quantities, and the statistic of the second equipment characteristic quantities associated with the at least one characteristic category to the first machine learning model, such that the first machine learning model outputs the first predicted probabilities corresponding to the predetermined maintenance items. For example, the processor 130 may input all the data in Table 1 except the difference inspection value to the first machine learning model.

In step S506, the processor 130 determines the at least one maintenance item according to the first predicted probabilities of the predetermined maintenance items output by the first machine learning model. In some embodiments, the processor 130 may determine whether the first predicted probabilities are greater than a probability threshold and identify the maintenance item applicable to the equipment from the predetermined maintenance items. Alternatively, in an embodiment, the processor 130 may rank the first predicted probabilities and identify predetermined maintenance items corresponding to several highest ranked first predicted probabilities as the maintenance items applicable to the equipment.

With reference to FIG. 5B, FIG. 5B is a flowchart of determining a maintenance item according to an embodiment of the disclosure. Step S312 may be implemented as step S508 to step S516.

In step S508, the processor 130 selects at least one target characteristic category from the at least one characteristic category according to the difference inspection value. In step S510, the processor 130 inputs the difference rate associated with the at least one target characteristic category, the statistic of the first equipment characteristic quantities, and the statistic of the second equipment characteristic quantities to a first machine learning model, the first machine learning model outputs a plurality of first predicted probabilities corresponding to a plurality of predetermined maintenance items. The implementation of step S508 to step S510 is similar to the implementation of step S502 to step S504 of FIG. 5A, and will not be repeatedly described here.

In step S512, the processor 130 obtains a textual abnormality description of the equipment. The textual abnormality description may be textual records input by equipment managing personnel or records in a factory manufacturing logbook.

In step S514, the processor 130 inputs the textual abnormality description to a second machine learning model, the second machine learning model outputs a plurality of second predicted probabilities corresponding to the predetermined maintenance items. The second machine learning model applies language processing machine learning algorithms, and is, for example, a Bidirectional Encoder Representations from Transformers (BERT) model or a Embeddings from Language Model (ELMo). In other words, model input data of the second machine learning model is a string of text. Following the examples of Table 1 and Table 2 for further description, Table 3 may be an example of input data and output data of the second machine learning model according to an embodiment of the disclosure.

TABLE 3

| Model input data | Model output data |
|---|---|
| Characteristic average of output volume in assessment interval is | 2nd predicted |
| less than current characteristic average; output volume in assessment | probabilities of |
| interval is less than factory output volume in assessment interval. | predetermined |
| Characteristic average of output temperature in assessment interval | maintenance items: |
| is greater than current characteristic average; output temperature in | (0.001, 0.450, 0.002, |
| assessment interval is greater than factory output temperature. | 0.495, 0.052) |

The processor 130 may input the model input data shown in Table 3 to the second machine learning model, such that the second machine learning model outputs a second predicted probability “0.001” corresponding to “oil mist separator”, a second predicted probability “0.450” corresponding to “air intake filter”, a second predicted probability “0.002” corresponding to “oil filter”, a second predicted probability “0.495” corresponding to “lubricant”, and a second predicted probability “0.052” corresponding to “coolant”.

In step S516, the processor 130 determines the at least one maintenance item according to the first predicted probabilities output by the first machine learning model and the second predicted probabilities output by the second machine learning model. In some embodiments, the processor 130 may perform weighted summation on the first predicted probabilities and the corresponding second predicted probabilities, and obtain weighted summation results respectively corresponding to the predetermined maintenance items. For example, the processor 130 may perform weighted summation on the first predicted probability “0.001” and the second predicted probability “0.001” of “oil mist separator” to obtain the weighted summation result of “oil mist separator”. The processor 130 may identify the maintenance item applicable to the equipment by performing operations such as threshold comparison, numerical ranking, or the like on the weighted sums.

In addition, some abnormal operating conditions of the equipment are suitable to be clearly presented with text, and some abnormal operating conditions of the equipment are suitable to be clearly presented with numerical values. Accordingly, the processor 130 can predict the maintenance item actually required by the equipment relatively accurately by applying the first machine learning model and the second machine learning model.

With reference to FIG. 5C, FIG. 5C is a flowchart of determining a maintenance item according to an embodiment of the disclosure. Step S312 may be implemented as step S518 to step S528.

In step S518, the processor 130 selects at least one target characteristic category from the at least one characteristic category according to the difference inspection value. In step S520, the processor 130 inputs the difference rate associated with the at least one target characteristic category, the statistic of the first equipment characteristic quantities, and the statistic of the second equipment characteristic quantities to a first machine learning model, the first machine learning model outputs a plurality of first predicted probabilities corresponding to a plurality of predetermined maintenance items. In step S522, the processor 130 obtains a textual abnormality description of the equipment. In step S524, the processor 130 inputs the textual abnormality description to a second machine learning model, the second machine learning model outputs a plurality of second predicted probabilities corresponding to the predetermined maintenance items. The implementation of step S518 to step S524 is similar to the implementation of step S508 to step S514 of FIG. 5B, and will not be repeatedly described here.

In step S526, the processor 130 inputs the first predicted probabilities and the second predicted probabilities to a third machine learning model, the third machine learning model outputs a plurality of third predicted probabilities corresponding to the predetermined maintenance items. The third machine learning model is, for example, a support vector machine (SVM) model, a random forest model, or the like. Nonetheless, the type of the model is not limited by the disclosure, and may be determined depending on the actual application.

Following the examples of Tables 1 to 3 for further description, Table 4 may be an example of input data and output data of the third machine learning model according to an embodiment of the disclosure.

TABLE 4

| Model input data | Model output data |
|---|---|
| 1st predicted probabilities: | 3rd predicted probabilities of |
| (0.001, 0.350, 0.002, 0.495, 0.152) | predetermined maintenance items: |
| 2nd predicted probabilities: | (0.001, 0.420, 0.002, 0.495, 0.082) |
| (0.001, 0.450, 0.002, 0.495, 0.052) | |

The processor 130 may input the model input data shown in Table 4 to the third machine learning model, such that the third machine learning model outputs a third predicted probability “0.001” corresponding to “oil mist separator”, a third predicted probability “0.420” corresponding to “air intake filter”, a third predicted probability “0.002” corresponding to “oil filter”, a third predicted probability “0.495” corresponding to “lubricant”, and a third predicted probability “0.082” corresponding to “coolant”.

In step S528, the processor 130 selects the at least one maintenance item from the predetermined maintenance items according to the third predicted probabilities of the predetermined maintenance items. In some embodiments, the processor 130 may determine whether the third predicted probabilities are greater than a probability threshold and identify the maintenance item applicable to the equipment from the predetermined maintenance items. Alternatively, in an embodiment, the processor 130 may rank the third predicted probabilities and identify predetermined maintenance items corresponding to several highest ranked third predicted probabilities as the maintenance items applicable to the equipment. For example, the processor 130 may identify the predetermined maintenance item corresponding to the highest third predicted probability and the predetermined maintenance item corresponding to the second highest third predicted probability as the maintenance items applicable to the equipment.

In addition, during training of the first machine learning model, the second machine learning model, and the third machine learning model, the ground truth required for machine learning may be labeled according to whether the maintenance items are actually carried out in historical maintenance records. For example, the ground truth required for machine learning may be (0, 1, 0, 1, 0). Here, “1” in the ground truth is to indicate that the corresponding predetermined maintenance item is actually carried out, and “0” in the ground truth is to indicate that the corresponding predetermined maintenance item is actually not carried out. Furthermore, it can be known that, during the process of training the first machine learning model, the second machine learning model, and the third machine learning model, generating the training data set is similar to generating the model input data in the embodiments shown in FIG. 4 and FIG. 5A to FIG. 5C.

After determining the maintenance item applicable to the equipment, the processor 130 may start to determine a consumables quantity corresponding to the maintenance item. As shown in FIG. 3, in step S314, the processor 130 obtains a plurality of combinations of consumables quantities corresponding to a first maintenance item and a second maintenance item according to a maximum consumables limit of the first maintenance item and a maximum consumables limit of the second maintenance item. Specifically, each maintenance item of the equipment has a maximum consumables limit. For example, assuming that the processor 130 determines the first maintenance item to be “air intake filter” and the second maintenance item to be “lubricant” according to Table 3, the processor 130 may obtain that the maximum consumables limit of “air intake filter” is 1 and the maximum consumables limit of “lubricant” is 2. In other words, at most 1 air intake filter and 2 barrels of lubricant are replaced for the equipment. Accordingly, the processor 130 may obtain the combinations of consumables quantities corresponding to the first maintenance item and the second maintenance item. The combinations of consumables quantities may be as shown in Table 5 below.

In step S316, the processor 130 inputs each combination of consumables quantities to an energy efficiency difference prediction model, and obtains an energy efficiency difference prediction value of each combination of consumables quantities. The energy efficiency difference prediction model is, for example, a linear regression model, a support vector machine (SVM) model, a random forest model, or the like. Specifically, the processor 130 may establish the energy efficiency difference prediction model by using the consumables quantity and the energy efficiency difference value (i.e., the difference between the energy efficiency before maintenance and the energy efficiency after maintenance) corresponding to the maintenance item of each maintenance in historical maintenance records. In addition, in some embodiments, the processor 130 may also perform ranking according to the energy efficiency difference prediction value corresponding to each combination of consumables quantities. Table 5 is an example provided according to the description above.

TABLE 5

| Combination of consumables quantities | | | |
|---|---|---|---|
| 1st maintenance | 2nd maintenance | Energy efficiency | |
| item (e.g., air | item (e.g., | difference | Combination |
| intake filter) | lubricant) | prediction value | ranking |
| 0 | 1 | 0.12 | 5 |
| 0 | 2 | 0.22 | 4 |
| 1 | 0 | 0.23 | 3 |
| 1 | 1 | 0.32 | 2 |
| 1 | 2 | 0.44 | 1 |

In step S318, the processor 130 determines an optimal combination of consumables quantities according to the energy efficiency difference prediction value of each combination of consumables quantities. In other words, the processor 130 may take the combination of consumables quantities corresponding to the greatest energy efficiency difference prediction value as the optimal combination of consumables quantities. According to Table 5, the optimal combination of consumables quantities is to replace 1 air intake filter and 2 barrels of lubricant. In addition, simply considering replacing a single maintenance item, according to Table 5, replacing the air intake filter is better than the lubricant. Accordingly, the above ranking may serve as a basis for the combination of maintenance items.

In addition, in some embodiments, maintenance consumables of different brands or different specifications achieve different improvement performances to energy efficiency of the same equipment. For example, lubricant of Specification A and lubricant of Specification B may achieve different improvement performances to energy efficiency of Equipment #1. Furthermore, maintenance consumables of the same brand or same specification achieve different improvement performances to energy efficiency of different equipment. For example, lubricant of Specification A may achieve different improvement performances to energy efficiency of Equipment #1 and Equipment #2.

Based on this, in some embodiments, the processor 130 may select an optimal consumables specification of the first maintenance item from a plurality of predetermined consumables specifications with reference to a consumables specification recommendation matrix of the first maintenance item. Each matrix element of the consumables specification recommendation matrix represents an energy efficiency difference value improved by a certain equipment using a certain consumables specification. Similarly, the processor 130 may select an optimal consumables specification of the second maintenance item from the predetermined consumables specifications with reference to a consumables specification recommendation matrix of the second maintenance item. Taking the first maintenance item being an air intake filter as an example, the processor 130 may select the optimal consumables specification of the air intake filter with reference to the consumables specification recommendation matrix shown in Table 6 below.

TABLE 6

Consumables specification

| Equipment No. | M1 | M2 | M3 | M4 |
|---|---|---|---|---|
| #1 | 0.32 | 0.12 | 0.33 | 0.43 |
| #2 | 1.02 | 0.33 | X | 0.45 |
| #3 | 0.34 | 0.04 | 0.06 | 0.08 |
| #4 | 1.12 | 0.37 | 0.04 | 0.54 |

If the processor 130 assesses Equipment #2, the processor 130 may use a recommendation algorithm (e.g., matrix factorization) for filling by linking to the relationship of the consumables specification “M3” on other equipment, and finally obtain X=0.09. After that, the processor 130 may select the optimal consumables specification “M1” of the air intake filter for equipment #2 according to the consumables specification recommendation matrix shown in Table 6 as 1.02>0.33>0.45>0.09. In some embodiments, consumables specification recommendation matrices corresponding to different equipment and different consumables specifications may be established based on historical maintenance records.

Based on the above operations, the processor 130 may not only identify the maintenance item applicable to the equipment, but also analyze the optimal consumables quantity and the optimal consumables specification corresponding to each maintenance item. Following the examples of Table 5 and Table 6 for further description, the processor 130 may obtain suggestion information as shown in Table 7.

TABLE 7

| | | | Optimal | Expected |
|---|---|---|---|---|
| Equip- | | Suggested | maintenance | energy |
| ment | Abnormality | maintenance | item | efficiency |
| No. | characteristics | item | combination | improvement |
| #2 | Output volume | Air intake | Air intake | 0.44 |
| | too low; output | filter; | filter of M1 | |
| | temperature | lubricant | specification *1; | |
| | too high | | lubricant of O2 | |
| | | | specification | |

In step S320, the processor 130 generates maintenance benefit assessment information of the equipment according to the energy efficiency difference prediction value corresponding to the optimal combination of consumables quantities. In some embodiments, the processor 130 may consider the current energy efficiency of the equipment, the unit electricity price, the regular maintenance period, the rated power of the equipment, and the energy efficiency difference prediction value (i.e., the expected energy efficiency improvement) to quantify advance maintenance costs of advance maintenance. For example, the processor 130 may calculate regular maintenance reduced cost C1 according to Formula (1). The processor 130 may calculate advance maintenance reduced cost C2 according to Formula (2).

$$C 1 = rated power \times unit electricity price \times \frac{expected energy efficiency improvement}{current energy efficiency} \times regular maintenance period \qquad Formula ( 1 )$$

$$C 2 = C 1 \times \frac{advance maintenance period}{regular maintenance period} \qquad Formula ( 2 )$$

Taking Table 7 and a regular maintenance period being 6 months (i.e., 4,000 hours) as an example for description, by substituting the expected energy efficiency improvement 0.44 into Formula (1), the processor 130 may obtain the regular maintenance reduced cost C1 of regular maintenance. Next, the processor 130 may obtain a plurality of advance maintenance reduced costs corresponding to different advance maintenance periods (e.g., 500 hours, 1,000 hours, 1,500 hours, 2,000 hours, 2,500 hours, 3,000 hours) according to Formula (2). Next, the processor 130 may divide the maintenance cost by the advance maintenance reduced cost generated from Formula (2) to obtain the number of months of amortization cost. The maintenance cost may be determined according to the consumables quantity and the consumables specification of the maintenance item.

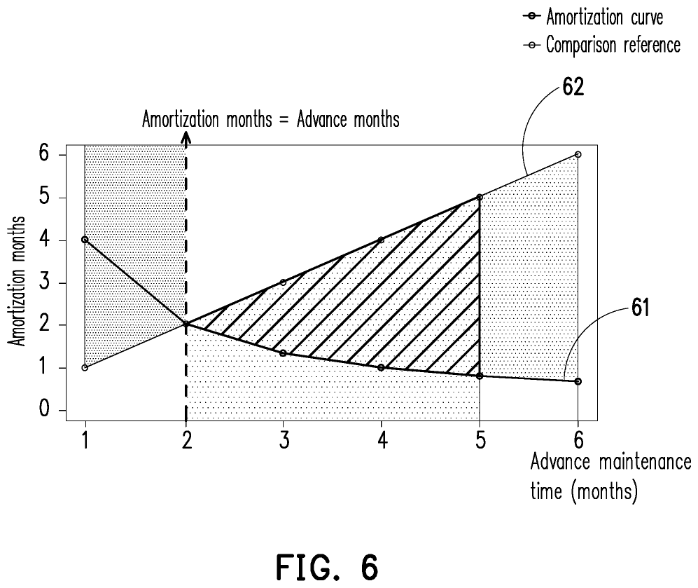

For example, FIG. 6 is a schematic diagram of maintenance benefit assessment information according to an embodiment of the disclosure. With reference to FIG. 6, assuming the regular maintenance period is 6 months, the processor 130 may calculate the number of months of amortization cost corresponding to each advance maintenance period according to the description above and Formula (1) and Formula (2), accordingly obtaining an amortization curve 61. A comparison reference 62 is established according to the number of months of amortization cost being equal to the advance maintenance period (i.e., the number of months of advance maintenance). According to the intersection between the amortization curve 61 and the comparison reference 62, the processor 130 can know the time point to start advance maintenance that may generate an estimated additional benefit. In the example of FIG. 6, in the case where the number of months of amortization cost is greater than the advance maintenance period (i.e., the advance maintenance period between 1 month and 2 months), no additional estimated additional benefits are generated. In the case where the number of months of amortization cost are less than the advance maintenance period (i.e., the advance maintenance period between 2 months and 5 months), additional cost saving benefits can be generated. In addition, if the advance maintenance period is excessively long, it indicates that the interval from the previous maintenance is excessively close, and it is not suggested to perform advance maintenance by so many hours (the advance maintenance period from 5 months to 6 months as shown in FIG. 6).

In addition, in an embodiment, the processor 130 may also calculate quantified additionally generated benefits of advance maintenance. For example, the processor 130 may calculate the estimated additional benefit of advance maintenance according to Formula (3).

$$Formula ( 3 )$$

$$estimated additional benefit = C 1 \times \frac{\begin{matrix}( months of advance maintenance - \\ months of amortization cost )\end{matrix}}{( regular maintenance period )}$$

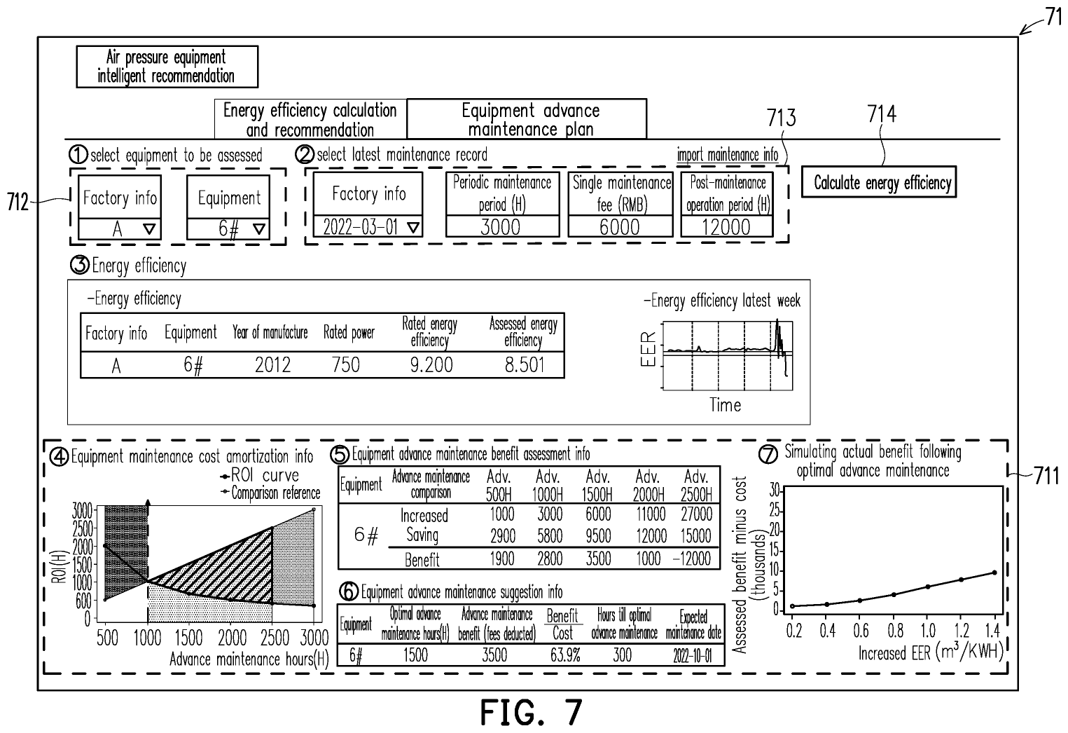

In step S322, the processor 130 provides suggestion information of the at least one maintenance item through the display 110. FIG. 7 is a schematic diagram of an operation interface with maintenance benefit assessment information according to an embodiment of the disclosure. With reference to FIG. 7, the display 110 may show an operation interface 71. Managing personnel may select the equipment to be performed with maintenance assessment in an interface field 712 of the operation interface 71. Here, it is assumed that the managing personnel selects equipment #6 in the interface field 712. The managing personnel may input the previous maintenance record in an interface field 713 of the operation interface 71. After that, the managing personnel may click an option 714 of the operation interface 71, such that the processor 130 may start to calculate energy efficiency of equipment #6 and determine whether to perform maintenance assessment. If the processor 130 determines that the energy efficiency of equipment #6 meets a maintenance condition, the processor 130 may display the maintenance assessment field 711. If the processor 130 determines that the energy efficiency of equipment #6 does not meet the maintenance condition, the processor 130 may not display the maintenance assessment field 711.

In addition, in FIG. 7, the maintenance assessment field 711 includes the benefit assessment information of advance equipment maintenance and the suggestion information of advance equipment maintenance. The benefit assessment information of advance equipment maintenance shows advance benefits corresponding to a plurality of advance maintenance periods. For example, the processor 130 may assess an advance benefit to be 1,900 for advance maintenance of equipment #6 by 500 hours. In addition, according to the advance benefits corresponding to the respective advance maintenance periods, the processor 130 may show the optimal advance maintenance period corresponding to the optimal advance benefit in the suggestion information of advance equipment maintenance. In FIG. 7, the optimal advanced maintenance period is 1,500 hours.

An embodiment of the disclosure further provides a computer readable recording medium. The computer readable recording medium stores a program. In response to a computer loads and executes the program, the computer readable recording medium performs the technical contents of the embodiments above.

In summary of the foregoing, in the embodiments of the disclosure, it is possible to timely suggest maintenance based on the characteristic status of the equipment when the equipment may require maintenance measures, and to automatically identify the maintenance item applicable to the equipment based on the characteristic status of the equipment. Based on this, equipment managing personnel can know when the equipment requires maintenance in time, and may carry out equipment maintenance according to the suggestion information of the identified maintenance item, so as to save electricity and reduce the factory costs. In addition, in the embodiments of the disclosure, the maintenance costs can be effectively reduced compared to carrying out maintenance operations on all maintenance items during the conventional process of regular maintenance measures. Furthermore, in the embodiments of the disclosure, based on the energy efficiency difference prediction model established according to past maintenance records and past energy efficiency difference performance of the equipment, the optimal consumables quantity and the optimal consumables specification of the maintenance item can also determined, accordingly effectively improving the operation energy efficiency of the equipment.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A method for suggesting equipment maintenance comprising:
obtaining equipment operation information of equipment;
determining energy efficiency of the equipment according to the equipment operation information;
generating status difference data of the equipment according to the equipment operation information in response to the energy efficiency meeting a maintenance condition;
determining at least one maintenance item corresponding to the equipment according to the status difference data; and
providing suggestion information of the at least one maintenance item through a display.

2. The method according to claim 1, wherein determining the energy efficiency of the equipment according to the equipment operation information comprises:
obtaining at least one production data of the equipment; and
determining the energy efficiency according to a ratio of the at least one production data to electricity consumption of the equipment,
wherein the method further comprises:
obtaining an energy efficiency measurement indicator by comparing the energy efficiency with predetermined energy efficiency;
comparing the energy efficiency measurement indicator with a measurement threshold; and
determining whether the energy efficiency meets the maintenance condition.

3. The method according to claim 1, wherein generating the status difference data of the equipment according to the equipment operation information in response to the energy efficiency meeting the maintenance condition comprises:
obtaining a plurality of first equipment characteristic quantities of the equipment corresponding to at least one characteristic category within a reference time interval;
obtaining a plurality of second equipment characteristic quantities of the equipment corresponding to the at least one characteristic category within a current time interval; and
generating a difference inspection value in the status difference data by comparing the first equipment characteristic quantities with the second equipment characteristic quantities.

4. The method according to claim 3, wherein generating the status difference data of the equipment according to the equipment operation information in response to the energy efficiency meeting the maintenance condition further comprises:
calculating a statistic of the first equipment characteristic quantities;
calculating a statistic of the second equipment characteristic quantities; and
generating a difference rate in the status difference data according to a difference between the statistic of the first equipment characteristic quantities and the statistic of the second equipment characteristic quantities.

5. The method according to claim 4, wherein determining the at least one maintenance item corresponding to the equipment according to the status difference data comprises:
selecting at least one target characteristic category from the at least one characteristic category according to the difference inspection value;
inputting the difference rate, the statistic of the first equipment characteristic quantities, and the statistic of the second equipment characteristic quantities associated with the at least one target characteristic category or the at least one characteristic category to a first machine learning model, the first machine learning model outputting a plurality of first predicted probabilities corresponding to a plurality of predetermined maintenance items; and
determining the at least one maintenance item according to the first predicted probabilities output by the first machine learning model.

6. The method according to claim 5, wherein determining the at least one maintenance item corresponding to the equipment according to the status difference data further comprises:
obtaining a textual abnormality description of the equipment; and
inputting the textual abnormality description to a second machine learning model, the second machine learning model outputting a plurality of second predicted probabilities corresponding to the predetermined maintenance items,
wherein determining the at least one maintenance item according to the first predicted probabilities output by the first machine learning model comprises:
determining the at least one maintenance item according to the first predicted probabilities output by the first machine learning model and the second predicted probabilities output by the second machine learning model.

7. The method according to claim 6, wherein determining the at least one maintenance item according to the first predicted probabilities output by the first machine learning model and the second predicted probabilities output by the second machine learning model comprises:
inputting the first predicted probabilities and the second predicted probabilities to a third machine learning model, the third machine learning model outputting a plurality of third predicted probabilities corresponding to the predetermined maintenance items; and
selecting the at least one maintenance item from the predetermined maintenance items according to the third predicted probabilities of the predetermined maintenance items.

8. The method according to claim 1, wherein the suggestion information of the at least one maintenance item comprises a consumables quantity and a consumables specification of the at least one maintenance item, the at least one maintenance item comprises a first maintenance item and a second maintenance item, and the method further comprises:
obtaining a plurality of combinations of consumables quantities corresponding to the first maintenance item and the second maintenance item according to a maximum consumables limit of the first maintenance item and a maximum consumables limit of the second maintenance item;
inputting each of the combinations of consumables quantities to an energy efficiency difference prediction model, and obtaining an energy efficiency difference prediction value of each of the combinations of consumables quantities;
determining an optimal combination of consumables quantities according to the energy efficiency difference prediction value of each of the combinations of consumables quantities, wherein the optimal combination of consumables quantities indicates a suggested consumables quantity for the first maintenance item and a suggested consumables quantity for the second maintenance item; and
selecting the consumables specification of the first maintenance item with reference to a consumables specification recommendation matrix of the first maintenance item, and selecting the consumables specification of the second maintenance item with reference to a consumables specification recommendation matrix of the second maintenance item.

9. The method according to claim 8, wherein the suggestion information of the at least one maintenance item comprises maintenance benefit assessment information, and the method further comprises:
generating the maintenance benefit assessment information of the equipment according to the energy efficiency difference prediction value corresponding to the optimal combination of consumables quantities.

10. The method according to claim 1, further comprising:
generating the status difference data of the equipment according to the equipment operation information in response to an operation period in the equipment operation information meeting a regular maintenance period.

11. An electronic device comprising:
a display;
a storage circuit storing a plurality of instructions;
a processor coupled to the display and the storage circuit, and accessing the instructions to:
obtain equipment operation information of equipment;
determine energy efficiency of the equipment according to the equipment operation information;
generate status difference data of the equipment according to the equipment operation information in response to the energy efficiency meeting a maintenance condition;
determine at least one maintenance item corresponding to the equipment according to the status difference data; and
provide suggestion information of the at least one maintenance item through the display.

12. The electronic device according to claim 11, wherein the processor further:
obtains at least one production data of the equipment;
determines the energy efficiency according to a ratio of the at least one production data to electricity consumption of the equipment;
obtains an energy efficiency measurement indicator by comparing the energy efficiency with predetermined energy efficiency;
compares the energy efficiency measurement indicator with a measurement threshold; and
determines whether the energy efficiency meets the maintenance condition.

13. The electronic device according to claim 11, wherein the processor further:
obtains a plurality of first equipment characteristic quantities of the equipment corresponding to at least one characteristic category within a reference time interval;
obtains a plurality of second equipment characteristic quantities of the equipment corresponding to the at least one characteristic category within a current time interval; and
generates a difference inspection value in the status difference data by comparing the first equipment characteristic quantities with the second equipment characteristic quantities.

14. The electronic device according to claim 13, wherein the processor further:
generates the status difference data of the equipment according to the equipment operation information in response to an operation period in the equipment operation information meeting a regular maintenance period;
calculates a statistic of the first equipment characteristic quantities;
calculates a statistic of the second equipment characteristic quantities; and
generates a difference rate in the status difference data according to a difference between the statistic of the first equipment characteristic quantities and the statistic of the second equipment characteristic quantities.

15. The electronic device according to claim 14, wherein the processor further:
selects at least one target characteristic category from the at least one characteristic category according to the difference inspection value;
inputs the difference rate, the statistic of the first equipment characteristic quantities, and the statistic of the second equipment characteristic quantities associated with the at least one target characteristic category or the at least one characteristic category to a first machine learning model, the first machine learning model outputting a plurality of first predicted probabilities corresponding to a plurality of predetermined maintenance items; and
determines the at least one maintenance item according to the first predicted probabilities output by the first machine learning model.

16. The electronic device according to claim 15, wherein the processor further:
obtains a textual abnormality description of the equipment;
inputs the textual abnormality description to a second machine learning model, the second machine learning model outputting a plurality of second predicted probabilities corresponding to the predetermined maintenance items; and
determines the at least one maintenance item according to the first predicted probabilities output by the first machine learning model and the second predicted probabilities output by the second machine learning model.

17. The electronic device according to claim 16, wherein the processor further:
inputs the first predicted probabilities and the second predicted probabilities to a third machine learning model, the third machine learning model outputting a plurality of third predicted probabilities corresponding to the predetermined maintenance items; and
selects the at least one maintenance item from the predetermined maintenance items according to the third predicted probabilities of the predetermined maintenance items.

18. The electronic device according to claim 11, wherein the suggestion information of the at least one maintenance item comprises a consumables quantity and a consumables specification of the at least one maintenance item, the at least one maintenance item comprises a first maintenance item and a second maintenance item, and the processor further:
obtains a plurality of combinations of consumables quantities corresponding to the first maintenance item and the second maintenance item according to a maximum consumables limit of the first maintenance item and a maximum consumables limit of the second maintenance item;
inputs each of the combinations of consumables quantities to an energy efficiency difference prediction model, and obtains an energy efficiency difference prediction value of each of the combinations of consumables quantities;
determines an optimal combination of consumables quantities according to the energy efficiency difference prediction value of each of the combinations of consumables quantities, wherein the optimal combination of consumables quantities indicates a suggested consumables quantity for the first maintenance item and a suggested consumables quantity for the second maintenance item; and
selects the consumables specification of the first maintenance item with reference to a consumables specification recommendation matrix of the first maintenance item, and selecting the consumables specification of the second maintenance item with reference to a consumables specification recommendation matrix of the second maintenance item.

19. The electronic device according to claim 18, wherein the processor further:
generates maintenance benefit assessment information of the equipment according to the energy efficiency difference prediction value corresponding to the optimal combination of consumables quantities.

20. A computer readable recording medium storing a program, in response to a computer loading the program, obtaining equipment operation information of equipment; determining energy efficiency of the equipment according to the equipment operation information; generating the status difference data of the equipment according to the equipment operation information in response to the energy efficiency meeting a maintenance condition; determining at least one maintenance item corresponding to the equipment according to the status difference data; and providing suggestion information of the at least one maintenance item through a display.
